(19) United States
(12) Patent Application Publication
(10) Pub. No.: US 2006/0251928 A1
(43) Pub. Date: Nov. 9, 2006

(54) Multilayer force sensor and method for determining a force

(76) Inventors: Eckhardt Quandt, Bonn (DE); Manfred Ruehrig, Eckental (DE); Stephan Schmitt, Munich (DE); Bernhard Winkler, Munich (DE); Joachim Wecker, Rottenbach (DE); Juergen Zimmer, Ottobrunn (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/366,767

(22) Filed: Mar. 1, 2006

(30) Foreign Application Priority Data
Mar. 1, 2005 (DE) 10 2005 009 390.6

(51) Int. Cl. G11B 5/39; G11B 5/33

(52) U.S. Cl. 428/811.2; 428/811.1; 428/811.5; 360/313; 360/316

(57) ABSTRACT

The invention relates to a force sensor having a layer sequence with at least two electrically conductive, magnetic layers which are arranged in succession and spaced apart from one another in a vertical direction. In each case, one separating layer is arranged between two adjacently arranged magnetic layers. Adjacently arranged magnetic layers have magnetostriction constants which are different from zero and have different signs. Each of the magnetic layers have one magnetization direction. In the quiescent state of the layer sequence, the magnetization directions of two adjacent magnetic layers are oriented essentially in parallel owing to ferromagnetic coupling, or essentially in antiparallel owing to antiferromagnetic coupling. Furthermore, the invention relates to an array for determining the mechanical deformation in a first direction of a carrier, a pressure sensor having such an array, and a method for determining a force acting on a force sensor.

### CROSS-REFERENCE TO RELATED APPLICATIONS

This Utility Patent Application claims priority to German Patent Application No. DE 10 2005 009 390.6, filed on Mar. 1, 2005, which is incorporated herein by reference.

### BACKGROUND

The invention relates to a force sensor and to a method for determining a force acting on a force sensor by means of a multilayer system with magnetostrictive layers.

Such multilayer systems make use of the fact that their electrical resistance changes under the influence of an external force. Such a multilayer system includes two or more magnetic layers. When the multilayer system deforms, for example under the effect of an external tensile force or compressive force, the magnetic directions of the individual magnetic layers change.

If, for example, a system with two such magnetic layers is considered, the electrical resistance of the system changes as a function of the angle which the magnetization directions of the two layers enclose.

The article S. Dokupil et al.: “Positive/negative magnetostrictive GMR trilayer systems as strain gauges” Journal of Magnetism and Magnetic Materials, Elsevier B. V., Jan. 18, 2005 discloses the use of a GMR-3 layer system as a strain sensor. The strain sensor is arranged in an external magnetic field here.

U.S. Pat. No. 6,694,822 B1 discloses the use of a multilayer thin film system as a force sensor. Here, ferromagnetic layers and nonmagnetic, conductive layers are arranged in alternation with one another. In one output state when an external tensile force or compressive force is not acting, the magnetic directions of the ferromagnetic layers are firstly oriented in parallel to one another. The magnetization directions of the ferromagnetic layers are rotated into a antiparallel orientation with respect to one another by means of an electric current flowing within the layer system. This state constitutes the initial state, and a force is measured starting from this state.

If an external force is acting on the force sensor which is in the initial state, the magnetization directions of adjacent magnetic layers are rotated out of their parallel or antiparallel array so that they enclose an angle which is greater than 0° and smaller than 180°. As the angle between the magnetization directions of adjacent magnetic layers changes, the electrical resistance of the thin film system changes so that the external force which is acting can be inferred from the resistance.

With this array, a current has to be applied to the multilayer system in order to bring about a defined orientation of the magnetization directions of the magnetic layers in the initial state by means of the magnetic field which is generated in this way. Since the current density required may be so high that the initial Joul heat can lead to a significant increase in temperature of the layer system and thus to measuring errors, it is proposed to apply the bias current in a pulsed fashion. However, this requires a relatively costly measuring circuit.

### SUMMARY

One embodiment of the present invention is to make available a force sensor and a method for determining a force acting on the force sensor by means of a multilayer system composed of magnetic layers in which there is no need for an electric current or a magnetic field for a defined orientation of the magnetization directions of the magnetic layers in the quiescent state of the force sensor.

The force sensor according to one embodiment of the invention has a layer sequence with at least two electrically conductive, magnetic layers which follow one another in a vertical direction and are arranged spaced apart from one another. In each case a nonmagnetic separating layer is arranged between two adjacently arranged magnetic layers.

The magnetic layers are formed in one case from magnetostrictive, soft magnetic material. Adjacent magnetic layers have magnetostriction constants which are different from zero and have different signs.

Furthermore, each of the magnetic layers has a magnetization direction, the magnetization directions of two adjacent magnetic layers being oriented essentially in parallel owing to ferromagnetic coupling, or essentially in antiparallel owing to antiferromagnetic coupling in the quiescent state of the layer sequence.

“Quiescent state” means here that the layer sequence does not have a current applied to it and that neither an external force nor an external magnetic field acts on it in order to bring about a defined orientation of the magnetization directions of the magnetic layers.

In the force sensor according to one embodiment of the invention, the orientation of the magnetization directions of adjacent magnetic layers in parallel or in antiparallel in the quiescent state is brought about by means of ferromagnetic or antiferromagnetic coupling. In the case of ferromagnetic coupling of two magnetic layers, the magnetizations are oriented in parallel, and in the case of antiferromagnetic coupling they are oriented in antiparallel.

This type of coupling of adjacent magnetic layers makes it possible to dispense with a system with a fixed exchange magnetization layer (spin valve structure).

Whether adjacent layers couple ferromagnetically or antiferromagnetically is determined by the RKKY (Rudermann Kittel Kasuyda Yosida) interaction and depends in particular on the distance between the adjacent magnetic layers. Owing to the RKKY interaction, ferromagnetic and antiferromagnetic coupling of these layers in an alternating fashion occurs as the distance between two magnetic layers increases.

As a result, the type of magnetic coupling of two adjacent magnetic layers can be set in a targeted fashion by their distance. For this purpose, nonmagnetic, or only weakly magnetic, separating layers are provided and they are arranged between the magnetic layers and their thicknesses are suitably selected.

According to one embodiment of the invention, the magnetization directions of adjacent magnetic layers of the layer sequence are oriented essentially in antiparallel in the quiescent state owing to antiferromagnetic coupling.

Likewise, the magnetization directions of all the magnetic layers of the layer sequence may be oriented essentially in parallel in the quiescent state owing to ferromagnetic coupling.

The magnetic layers in one case have magnetic anisotropy, and particularly have uniaxial magnetic anisotropy. Such uniaxial magnetic anisotropy has the feature that the magnetization directions in the quiescent state assume a defined primary state. Furthermore, such uniaxial magnetic anisotropy brings about a restoring force when the magnetization directions are deflected from their quiescent position.

Such uniaxial magnetic anisotropy can be brought about in various ways.

On the one hand, uniaxial magnetic anisotropy can be obtained by means of the geometric shape of the layer sequence. If the layer sequence has, for example, an elongate form, the magnetization directions are oriented in parallel to the longitudinal axis of the layer sequence. Such an anisotropy is also referred to as magnetic shape anisotropy.

As an alternative to, or in addition to, shape anisotropy it is also possible to bring about uniaxial magnetic anisotropy by annealing the magnetic field or by depositing the magnetic layers in a (bias) magnetic field.

According to one embodiment of the invention, the layer sequence has such a length in a first lateral direction which is perpendicular to the vertical direction, and such a width in a second lateral direction which is perpendicular to the vertical direction and to the first lateral direction, that the ratio between the length and the width is greater than 2:1. The width is in one case in the range from 0.2 μm to 200 μm, and in one case in the range 0.5 μm to 15 μm. Such an elongate shape of the layer sequence promotes shape anisotropy in the quiescent state of the layer sequence, with adjacent magnetic layers which are oriented in parallel or in antiparallel to the first lateral direction.

When an external force is acting on the layer sequence, the relative orientation of the magnetization directions of adjacent magnetic layers changes owing to inverse magnetostriction, and this entails a change in the electrical resistance of the layer sequence. As a result, the acting force can be inferred from the electrical resistance of the layer sequence.

The separating layers which are arranged between the magnetic layers are in one case formed from nonmagnetic material, or only weakly magnetic material, and can be electrical conductors or electrical insulators.

In the case of electrically conductive separating layers, the change in electrical resistance of the layer sequence is based on the gigantic magnetoresistive (GMR) effect. A change in electrical resistance of the layer sequence which is brought about by an external force acting on the layer sequence can be measured in any direction of the layer sequence. However, in the case of layer sequences which are embodied so as to be elongate, the electrical resistance is measured in the longitudinal direction.

However, the separating layers can, on the other hand, also be formed from electrically insulating material. In this case, the tunnel magnetoresistive (TMR) effect comes into play. In the case of the TMR effect, the electrical resistance is measured in the vertical direction, that is to say perpendicularly with respect to the separating layers and the magnetic layers. In this case, a separating layer which is arranged between two magnetic layers firstly acts as an insulator. However, if the separating layer is made sufficiently thin, electrons can pass through the separating layer as a result of the tunnel effect.

The electrical resistance of the layer sequence changes as a function of the relative orientation of the magnetization directions of adjacent magnetic layers both with the GMR effect and with the TMR effect. With both effects, the smallest resistance between two adjacent magnetic layers occurs if the magnetization directions enclose an angle of 0°, that is to say are oriented in parallel to one another. The largest resistance occurs if the magnetization directions enclose an angle of 180°, that is, if they are oriented in antiparallel to one another.

The change in resistance which occurs with the same force and the same coupling of adjacent magnetic layers is all the greater the greater the magnitudes of the magnetostriction constants of the coupled layers. The magnitudes of the magnetostriction constants of the magnetic layers are in one case greater than 0.00001.

Such a change in resistance which is brought about by the change in the relative orientation of the magnetization directions of adjacent magnetic layers is brought about primarily in the junction region between the adjacent magnetic layers. In order to increase the change in resistance which is brought about by a specific external force acting on a layer sequence, it is advantageous if the layer sequence has a plurality of adjacent layer sequences provided that their magnetization directions are suitably selected. As long as the overall thickness of the layer sequence is lower here than the characteristic free travel length for a spin flip of the electrons, an increase in the GMR effect can be achieved by increasing the number of layer sequences.

The direction in which the magnetization direction of a magnetic layer is rotated when an external force is acting on the layer sequence depends both on the direction of the external force and on the sign of the magnetostriction constant of the respective magnetic layer.

If the magnetostriction constant is positive, the rotation of the magnetization direction of the magnetic layer is in the direction of the axis of the external force, and if the magnetostriction constant is negative with respect to the axis it is perpendicular with respect to the direction of the external force.

The present invention also includes a method for determining the force acting on a force sensor. Firstly, the method makes available a force sensor such as has been described above. If the layer sequence is deformed owing to a force acting on the force sensor, the force can be determined by determining the electrical resistance using a characteristic curve which represents the relationship between the electrical resistance of the layer sequence and the force acting on the layer sequence.

A further aspect of one embodiment of the invention is aimed at determining the mechanical deformation of a carrier.

Four identical force sensors according to one embodiment of the invention are arranged on the carrier. A first and a second of the force sensors have longitudinal axes which are perpendicular with respect to the first direction. Furthermore, a third and a fourth of the force sensors have longitudinal axes which are parallel to the first lateral direction.

According to one embodiment of the invention, the four force sensors are connected to form a Wheatstone bridge. By means of such a bridge circuit it is possible to compensate for both temperature-related or ageing-related changes and for fabrication-related fluctuations in the basic resistance. In order to obtain a temperature dependence which is as low as possible, in one embodiment the four force sensors are in thermal contact with one another.

Such an array can be used, for example, with a pressure sensor, the carrier forming the diaphragm of the pressure sensor. The pressure sensor diaphragm is attached to a diaphragm carrier and bridges an opening formed in the diaphragm carrier.

In one embodiment, the first and the second force sensor are arranged in a region of the diaphragm in which the greatest forces occur when the diaphragm deforms. This is typically in the region above the opening in the diaphragm carrier, in the vicinity of the edge of the opening. In contrast, the third and the fourth force sensors are arranged in a region in which no forces, or only small forces, occur when the diaphragm deforms.

Given good thermal coupling of the four force sensors, the third and the fourth force sensors are used as reference sensors, for example for temperature compensation.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a force sensor according to one embodiment of the invention in a perspective view.

FIG. 2 is a vertical section, illustrated in an enlarged form, through a force sensor according to FIG. 1, in which adjacent magnetic layers have antiferromagnetic coupling.

FIG. 3 is a vertical section, illustrated in an enlarged form, through a force sensor according to FIG. 1 in which adjacent magnetic layers have a ferromagnetic coupling.

FIG. 4 illustrates the profile of the magnetic coupling of two adjacent magnetic layers as a function of the distance between them.

FIGS. 5a-d illustrate the relative orientation of the magnetization directions of two adjacent magnetic layers of the force sensor according to FIG. 2 with different external forces.

FIG. 6 illustrates an array for measuring the electrical resistance with a force sensor which is based on the GMR effect.

FIG. 7 illustrates an array for measuring the electrical resistance with a force sensor which is based on the TMR effect.

FIG. 8 illustrates the resistance/force characteristic curve of a force sensor according to one embodiment of the invention.

FIG. 9 illustrates an array for determining the deflection of a bending beam, connected to a carrier, by means of a force sensor according to one embodiment of the invention.

FIG. 10a illustrates a vertical section through the diaphragm of a pressure sensor.

FIG. 10b illustrates a plan view of the diaphragm of the pressure sensor according to FIG. 10a.

FIG. 11 illustrates a bridge circuit composed of four force sensors according to one embodiment of the invention.

FIG. 12 illustrates a characteristic curve of the pressure obtained with the pressure sensor according to FIGS. 10a, 10b, plotted as a function of the output voltage of the bridge circuit according to FIG. 11.

FIG. 13 illustrates a force sensor according to one embodiment of the invention as in FIG. 1 with a plurality of magnetic layers which are parallel to one another and are spaced apart from one another by means of separating layers.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the FIG.(S) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

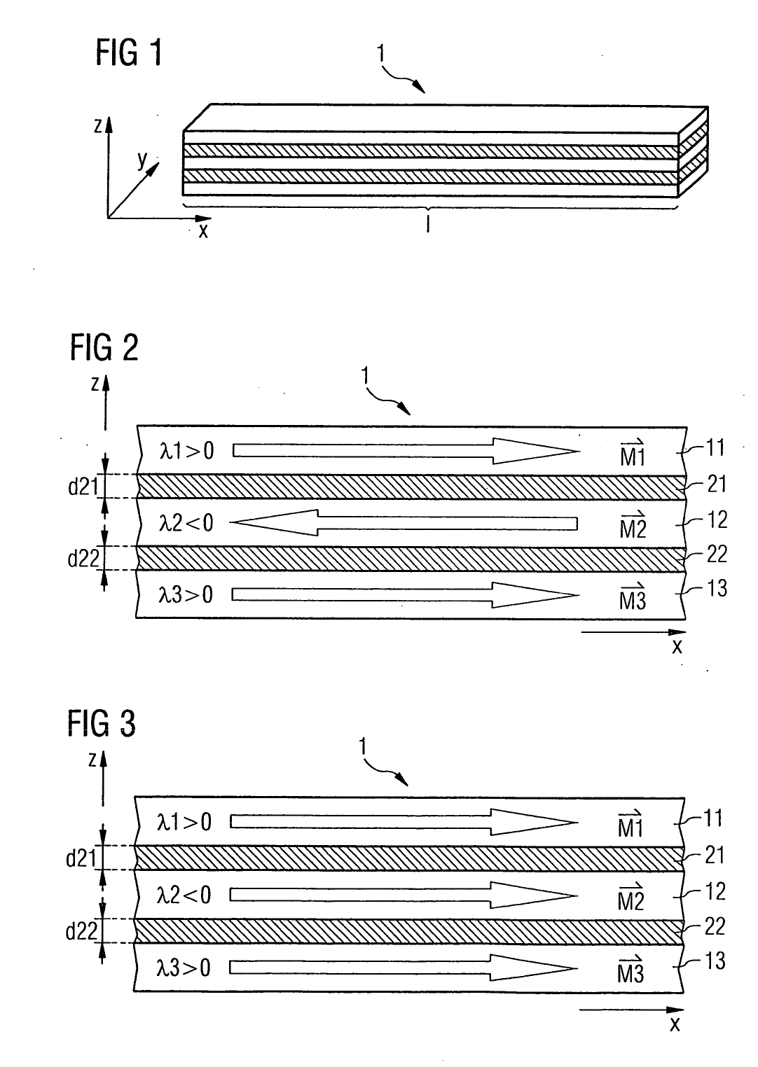

FIG. 1 illustrates a perspective view of a force sensor 1 according to one embodiment of the invention. The force sensor 1 includes a layer sequence with a plurality of magnetic layers 11, 12, 13 arranged spaced apart from one another in a vertical direction z. Separating layers 21 and 22, which are formed from nonmagnetic material or material with a low level of magnetism are arranged between adjacent magnetic layers 11, 12 and 12, 13.

A force sensor according to one embodiment of the invention includes at least two magnetic layers since its electrical resistance is determined in particular by the relative position of the magnetization directions of two adjacent magnetic layers. In the upward direction the number of magnetic layers is unlimited.

The layer sequence has a length I in a first lateral direction x which is perpendicular to the vertical direction v, and a width b in a second lateral direction y which is perpendicular to the vertical direction z and to the first lateral direction x. The layer sequences of force sensors according to one embodiment of the invention have an elongated form with a ratio of length 1 to width b which is in one case greater than 2:1. The width b is in one case between 0.2 μm and 200 μm, and in one case between 0.5 μm and 15 μm.

FIG. 2 illustrates an enlarged vertical section through a portion of a layer sequence in the quiescent state, corresponding to FIG. 1. “Quiescent state” is understood below to be the state in which no external forces and no external magnetic field is acting on the layer sequence, and in which no current is flowing in the layer sequence.

According to one embodiment of the invention, the adjacent magnetic layers 11, 12 and 12, 13 are coupled antiferromagnetically, that is, the magnetizations M1, M2, M3 of adjacent magnetic layers 11, 12 and 12, 13 are oriented in antiparallel.

A corresponding array in which adjacent magnetic layers 11, 12 and 12, 13 are coupled ferromagnetically is illustrated in FIG. 3. Here, the magnetizations M1, M2, M3 of the magnetic layers 11, 12, 13 are oriented parallel to one another in the quiescent state.

The type of magnetic coupling of two magnetic layers depends on the distance between them. As illustrated in FIG. 3, the magnetic coupling J oscillates between ferromagnetic coupling (FM) and antiferromagnetic coupling (AFM) between these layers as the distance d between the layers increases.

The magnetic coupling J has a cosign-shaped profile and has an amplitude which decreases as the distance d between the layers increases. Owing to the oscillation, extreme values follow one another at the intervals d11, d21, d12, d22 etc. with alternating antiferromagnetic and ferromagnetic coupling as the distance d between the layers increases.

The distance between adjacent magnetic layers is selected in one case such that it is identical to a distance d11, d21, d12, d22 etc. at which the magnetic coupling J of the respective adjacent layers assumes an extreme value.

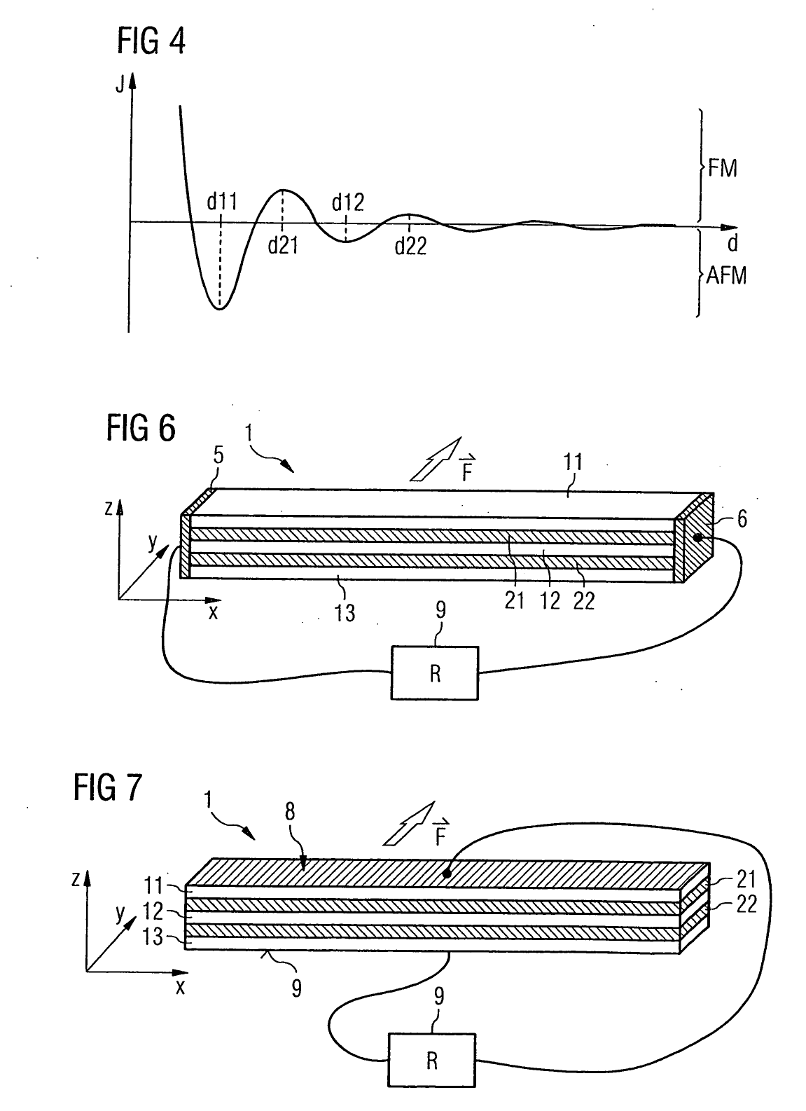

As is illustrated in FIG. 2, the first magnetic layer 11 and the second magnetic layer 12 are at a distance d11 from one another. From FIG. 4, which illustrates the profile of a magnetic coupling (RKKY coupling) of adjacent layers it is apparent that antiferromagnetic coupling occurs with a distance d11 between layers. As a result, the magnetizations M1 and M2 of the first and second magnetic layers 11, 12 according to FIG. 2 are oriented in antiparallel, which is indicated by corresponding arrows. A precondition for this is that the force sensor is in the quiescent state, that is to say no external force and no external magnetic field is acting on it and that a current is not flowing through it.

Furthermore it is apparent from FIG. 4 that ferromagnetic coupling of adjacent layers occurs when there is a distance d21 between layers. Owing to a correspondingly selected distance d21 between the first and second magnetic layers 11, 12 according to FIG. 3, the adjacent magnetic layers 11, 12 couple ferromagnetically here. For this reason, the magnetization directions M1, M2 are oriented in parallel.

In order to set a predefined coupling between adjacent magnetic layers according to FIGS. 2 or 3 in a targeted fashion, the invention provides for the thickness of the separating layers 21 and 22 which are arranged between the adjacent magnetic layers 11, 12 and 12, 13 to be adapted in accordance with the desired value and the desired sign of the magnetic coupling J.

Basically, distances at which the magnetic coupling J does not have an extreme value as long as its value is different from zero can also be selected for the distances between adjacent magnetic layers.

Furthermore, the magnetic layers 11, 12, 13 are formed from magnetostrictive material. If an external force acts on the force sensor, a change occurs in the magnetization directions M1, M2, M3 in the magnetic layers 11, 12, 13 owing to the inverse magnetostriction in said layers 11, 12, 13. The way in which the magnetization directions M1, M2, M3 of a magnetic layer 11, 12, 13 changes depends here on the sign of the magnetostriction constants λ1, λ2, λ3 of the respective magnetic layer 11, 12, 13.

As is apparent from FIGS. 2 and 3, adjacent magnetic layers 11, 12 and 12, 13 have magnetostriction constants λ1, λ2 and λ2, λ3 with different signs.

If, for example, an external tensile force is acting on the force sensor 1 starting from the quiescent state illustrated in FIGS. 2 and 3, the magnetization directions M1, M3 of the magnetic layers 11, 13 rotate with a positive magnetostriction constant λ1 or λ3 in the direction of the axis of the acting force.

In the case of a compressive force which is acting on the force sensor 1 in the direction of the same axis, the magnetization directions M1, M3 of the magnetic layers 11, 13 would become oriented in the direction of an axis perpendicular to the axis of the acting compressive force.

Owing to the negative magnetostriction constant λ2 of the second magnetic layer 12, its magnetization direction M2 becomes oriented in the direction of an axis which extends perpendicularly with respect to the axis to which the magnetization directions M1, M3 attempt to orient themselves.

This means that, starting from the initial orientation, that is, an orientation which is parallel or antiparallel when there is no force, the magnetization direction M1 becomes increasingly oriented perpendicularly with respect to the magnetization direction M2, and the magnetization direction M2 becomes increasingly oriented perpendicularly with respect to the magnetization direction M3 as the acting force increases in magnitude.

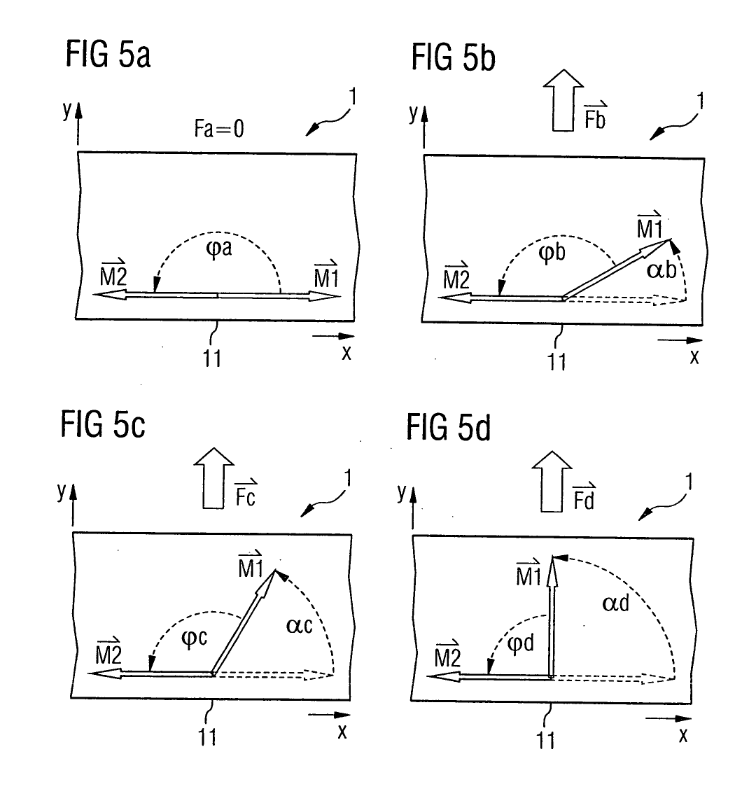

This is illustrated in FIGS. 5a-d using the example of the force sensor illustrated in FIG. 2. The first and second magnetic layers 11, 12 are coupled antiferromagnetically as explained above.

FIG. 5a illustrates a plan view of the first magnetic layer 11 of the layer sequence of the force sensor 1 according to FIG. 2. The magnetization direction M1 of the uppermost magnetic layer 11 and the magnetization M2, which is antiparallel thereto in the quiescent state, of the second magnetic layer 12 lying underneath it are illustrated symbolically. FIG. 5a illustrates the quiescent state of the force sensor (external force Fa=0) in which the magnetization directions M1 and M2 enclose an angle αa of 180°.

FIG. 5b illustrates the force sensor according to FIG. 5a but with a tensile force Fb which is acting on the force sensor 1 in a second lateral direction y. As a result of this tensile force Fb, the magnetization M1 rotates in the direction of the axis of the acting tensile force Fb by an angle αb owing to inverse magnetostriction. Since uniaxial anisotropy is formed owing to the magnetostrictive effect as a result of the extension of the layer sequence, it is equivalent in terms of energy, when there is no further external force and no preferred magnetic directions, if the magnetization M1 rotates through an angle-αβ. However, the same value applies for the resistance.

FIGS. 5c and 5d illustrate the same force sensor as FIG. 5b but with higher tensile forces Fc and Fd acting. In FIGS. 5b to 5d the size of the acting force Fb, Fc and Fd is represented by the size of the corresponding arrows.

From FIGS. 5b to 5d it is apparent that as the external force Fb, Fc, Fd increases, more and more pronounced orientation of the magnetization M1 of the first magnetic layer 11 in the direction of the axis of the external tensile force Fb, Fc, Fd occurs. In the boundary case of an infinitely large external force, the angle between the magnetization directions of adjacent magnetic layers deviates by 90° from the angle which the magnetization directions of this magnetic layer enclose in the quiescent state.

In contrast, the direction of the magnetization M2 of the second magnetic layer 12 is not influenced by the acting forces Fb, Fc, Fd since the second magnetic layer 12 has a negative magnetostriction constant λ2, and since the magnetization M2 is already oriented perpendicularly with respect to the acting external force Fb, Fc, Fd in the quiescent state.

As is apparent from the FIGS. 5a to 5d, angles φa, φb, φc and φd occur between the magnetization direction M1 of the first magnetic layer 11 and the magnetization direction M2 of the second magnetic layer 12 depending on external forces Fa, Fb, Fc and Fd. These angles may vary from 180° and 90°.

The electrical resistance of two adjacent magnetic layers 11, 12 depends in particular on the relative position of their magnetization directions, that is, on the cosign of the intermediate angle φa, φb, φc, φd which the magnetization directions M1, M2 enclose depending on the external force Fa, Fb, Fc or Fd. As a result, the force Fa, Fb, Fc, Fd which is acting from the outside can be inferred from the determination of the electrical resistance of the force sensor 1.

The sensing of the acting force is based on an equilibrium, dependent on the force, between the magnetic anisotropy which is caused by the extension and the restoring forces which result from the exchange couplings (RKKY) of adjacent ferromagnetic layers and the magnetic anisotropy which is required to define the axis of the quiescent state. This means that optimum sensitivity can be set by adjusting the exchange coupling and the magnetostriction constant for a specific range of extension.

When the electrical resistance of the force sensor 1 is determined it is possible to differentiate between two variants.

The first variant is illustrated in FIG. 6. The force sensor 1 shown corresponds in its design to the force sensor 1 according to FIG. 1. The decisive factor is that the separating layers 21, 22 which are arranged between the magnetic layers 11, 12, 13 are electrically conductive. Owing to the gigantic magnetoresistive (GMR) effect, which is based on a spin-spin interaction of electrons of adjacent magnetic layers 11, 12, 13, an electrical resistance R which depends on the angle φa, φb, φc, φd between the magnetization directions M1, M2, as has been illustrated with reference to FIGS. 5a to 5d, occurs in the force sensor 1.

A change in the electrical resistance can be observed here irrespective of the direction of the layer sequence in which the electrical resistance is determined.

According to one embodiment of the invention which is illustrated in FIG. 6, the force sensor 1 is embodied in an elongate fashion so that the electrical resistance R can be determined in the longitudinal direction of the force sensor 1. For this purpose, the force sensor 1 is provided on opposite sides with electrodes 5, 6 to which a device 9 for determining the electrical resistance of the force sensor 1 is connected. The measured electrical resistance R changes as a result of the application of an external force F to the force sensor 1.

The second variant is illustrated in FIG. 7. The force sensor 1 illustrated corresponds to the force sensor 1 according to FIG. 1. In this variant it is decisive that the separating layers 21, 22 which are arranged between the magnetic layers 11, 12, 13 are electrical insulators. A device 9 for determining the electrical resistance is connected in an electrically conductive fashion to the first magnetic layer 11 and to the third magnetic layer 13. For this purpose, the uppermost and the lowermost magnetic layers 11 and 13 can have electrodes 8 and 9, respectively. Owing to the insulating separating layers 21, 22 the electrical resistance R which is determined is quasi-infinite.

However, owing to the tunnel effect, charge carriers pass (“tunnel”) through the electrically insulating separating layers 21, 22 so that an infinite value of the measured resistance R occurs.

Owing to the tunnel magnetoresistive effect, this electrical resistance R depends in turn on the relative position of the magnetization directions M1, M2 of adjacent magnetic layers 11, 12 and 12, 13, as has been illustrated with reference to FIGS. 5a to 5d.

Both with the GMR effect and with the TMR effect, the electrical resistance of adjacent magnetic layers 11, 12 and 12, 13 is at its smallest if their magnetization directions are oriented in parallel, and at its largest if their magnetization directions are oriented in antiparallel.

As a result, providing that the calibration is suitable, the external force which is acting on a force sensor 1 can be inferred from a known resistance/force characteristic curve from measuring the electrical resistance of said force sensor 1.

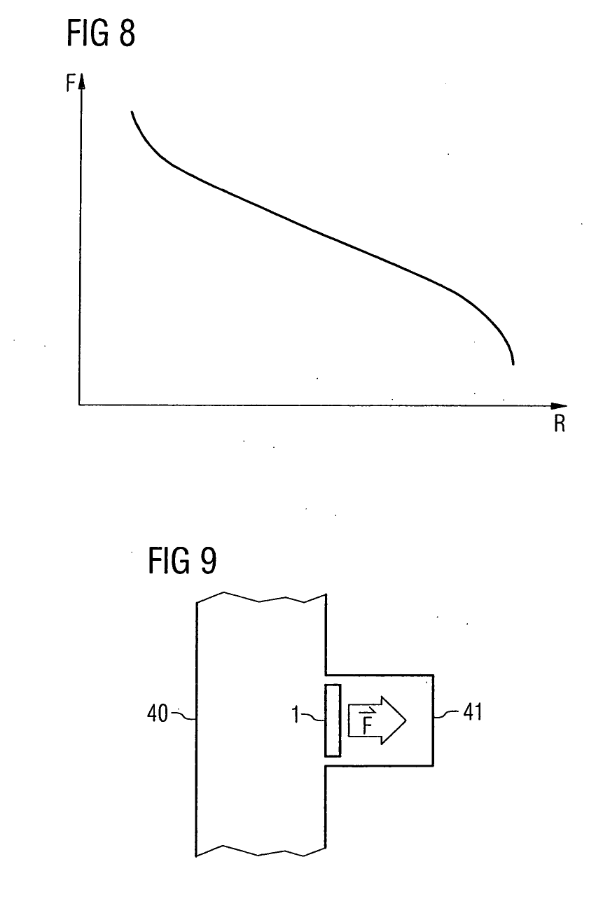

FIG. 8 illustrated by way of example such a resistance/force characteristic curve. When there is no external force, or only a small external force, the magnetization directions of adjacent magnetic layers are oriented entirely, or virtually completely entirely, in antiparallel so that the force sensor has a high resistance. As the external force increases, the electrical resistance of adjacent magnetic layers progressively decreases owing to the angle between the magnetizations of adjacent magnetic layers becoming smaller.

FIG. 9 illustrated by way of example an application of a force sensor according to one embodiment of the invention. A bending bar 41 is attached to a carrier 40 or formed integrally with the latter. In the region of the greatest degree of bending of the bending bar 41, a force sensor 1 according to one embodiment of the invention is attached. The force sensor 1 has the design corresponding to the force sensor 1 according to FIG. 1. It is of elongate design and is oriented in such a way that when the bending bar is bent in a direction perpendicular with respect to the plane of illustration a force F acts on it perpendicularly with respect to its longitudinal axis. In one case, the force sensor 1 is attached in the region of the bending bar 41 in which the highest bending stresses occur when it is bent.

Given suitable calibration the bending of the bending bar 41 can be inferred from the electrical resistance of the force sensor 1.

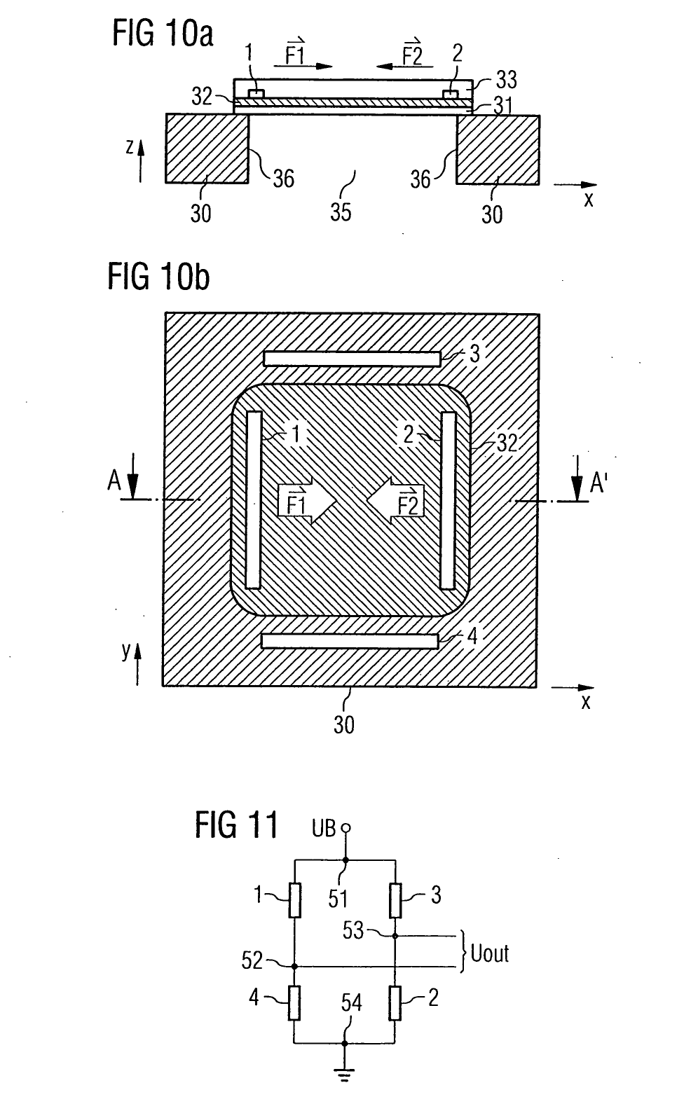

A further application possibility of force sensors according to the invention is, for example, in pressure sensors. FIG. 10a illustrates a vertical section through the diaphragm region of a pressure sensor.

A diaphragm carrier 30 has an opening 35 which is covered by a diaphragm 31 which is formed, for example, from silicon. An insulating layer 32 is arranged on the diaphragm 31 and has a first and a second force sensor 1, 2 according to the invention positioned on it. The first and second force sensors 1, 2 are arranged above the opening 35 in the diaphragm carrier 30, in one case near to the edge 36 of the opening 35, on the diaphragm 31.

A passivation layer 33 is deposited on the insulating layer 32 and the force sensors 1, 2.

Depending on the pressure acting on the pressure sensor, a greater or lesser degree of bulging of the diaphragm 31 occurs, and therefore forces F1, F2 occur which act essentially perpendicularly with respect to the longitudinal axis of the force sensors 1, 2.

The view according to FIG. 10a illustrates a sectional view in a plane A-A′ of the section of the pressure sensor illustrated in FIG. 10b.

FIG. 10b illustrates a plan view of the array according to FIG. 10a with the passivation layer 33 removed. The diaphragm, which is arranged under the insulating layer 32 in this view, and the insulating layer 32 are of essentially rectangular or square design. A third and a fourth force sensor according to embodiments the invention are provided in the array. The four force sensors 1, 2, 3, 4 are in one case of identical, elongate design.

In one case, the first and second force sensors 1, 2 have parallel longitudinal axes.

The third and fourth force sensors 3, 4 correspondingly also have parallel longitudinal axes. In contrast to the force sensors 1, 2, the force sensors 3, 4 are not arranged above the opening in the diaphragm carrier 30 but rather above the diaphragm carrier 30 on the diaphragm 31 and the insulating layer 32. The longitudinal axes of the first and second force sensors 1, 2 in one case extend perpendicularly with respect to the longitudinal axes of the third and fourth force sensors 3, 4.

When a pressure acts on the diaphragm, forces F1, F2 occur which act perpendicularly on the longitudinal axes of the force sensors 1, 2, as described in FIG. 10a.

Since the third and fourth force sensors 3, 4 are arranged above the diaphragm carrier 30 and perpendicularly with respect to the first and second force sensors 1, 2, no significant forces act on the third and fourth force sensors 3,4.

When the diaphragm bulges as a result of a force acting on the pressure sensor, the electrical resistances of the first and second force sensors 1, 2 change so that the acting pressure can be inferred from the electrical resistance of the first and second force sensors 1, 2.

However, owing to temperature or ageing for example, it is possible for changes in resistance of the force sensors 1, 2 to occur and these changes can falsify the result of a pressure measurement which is based on the measurement of the resistances of the first and second force sensors 1, 2.

However, since the temperature-related and ageing-related changes in resistance—given good thermocoupling of the first, second, third and fourth force sensors 1, 2, 3, 4—of the third or fourth force sensors 3, 4 with force sensors 1, 2, 3, 4 which are of identical design are identical to a good degree of approximation to the temperature-related changes in resistance of the first and second force sensors 1, 2, the third and fourth force sensors 3, 4 can be used to compensate temperature-related or ageing-related measuring errors.

This is done in one case by means of a Wheatstone bridge circuit as illustrated in FIG. 11.

The first force sensor 1 is connected to a first connecting point 51 and to a second connecting point 52. The third force sensor is connected to the first connecting point 51 and to a third connecting point 53. Furthermore, the second force sensor 2 is connected to the third connecting point 52 and to a fourth connecting point 54, and the fourth force sensor 4 is connected to the second connecting point 52 and the fourth connecting point 54.

The connecting points 51 and 54 are provided for supplying the bridge circuit with a supply voltage UB.

The bridge output voltage Uout which is present between the second and third connecting points 52, 53 is a measure of the pressure acting on the diaphragm of the pressure sensor according to FIGS. 10a and 10b.

With an array according to FIGS. 10a, 10b, in particular when a bridge circuit according to FIG. 11 is used, it is possible to determine the pressure acting on a pressure sensor by measuring the electrical resistances of the first, second, third and fourth force sensors 1, 2, 3, 4 in conjunction with a suitable characteristic curve.

The sensor array presented in FIGS. 10a and 10b and the bridge circuit illustrated in FIG. 11 can be applied not only in pressure sensors but also can easily be adapted to analogous objectives by a person skilled in the art.

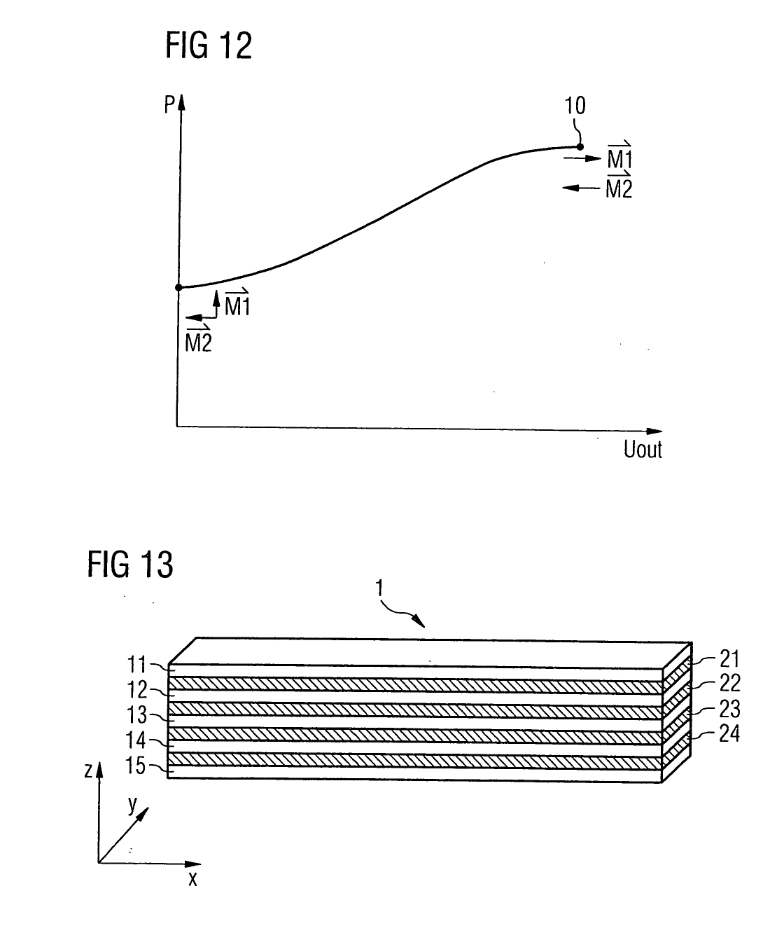

FIG. 12 illustrates a calibrated characteristic curve of a pressure sensor according to FIGS. 10a, 10b which is provided with a bridge circuit according to FIG. 11. The associated pressure can be determined in conjunction with the characteristic curve by determining the output voltage Uout of the bridge.

In all the applications, it is possible to use both force sensors, which are based on the GMR effect as described with reference to FIG. 6, and force sensors which are based on the TMR effect, as described in FIG. 7.

Irrespective of the underlying effect, a force sensor can have any desired number of magnetic layers, at least two magnetic layers being necessary. FIG. 13 illustrated by way of example an array composed of four magnetic layers 11, 12, 13, 14, 15 which are each spaced apart from one another in the vertical direction Z and between each of which a separating layer 21, 22, 23, 24 is arranged.

In order to be able to measure a predefined measuring range with the force sensor according to one embodiment of the invention, in particular suitable dimensioning of the layer sequence is necessary. The smaller the distances between adjacent magnetic layers, the greater their magnetic coupling and the more external force is necessary to deflect the magnetizations out of the quiescent position by a specific angle.

In one case, soft magnetic materials are used to manufacture the magnetic layers of a force sensor according to one embodiment of the invention.

For example iron-cobalt alloys (FeCo, for example Fe50Co50), in particular amorphous iron-cobalt boron silicon alloys (FeCoBSi), are suitable for manufacturing magnetic layers with a positive magnetostriction constant.

Suitable materials with a negative magnetostriction constant are, for example, nickel (Ni).

In one case, nonmagnetic materials, or only weakly magnetic materials, such as copper in copper alloys are used as electrically conductive separating layers in force sensors which are based on the GMR effect.

Correspondingly, nonmagnetic, or only weakly magnetic, materials such as aluminum oxide (Al₂O₃) or magnesium oxide (MgO) are in one case used as the electrically insulating separating layers in force sensors which are based on the TMR effect.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A force sensor comprising:
a layer sequence with at least two electrically conductive, magnetic layers arranged in succession and spaced apart from one another in a vertical direction;
one separating layer arranged between each two adjacently arranged magnetic layers;
wherein the adjacently arranged magnetic layers have magnetostriction constants that are different from zero and have different signs;
wherein each of the magnetic layers have one magnetization direction;
wherein the magnetization directions of two adjacent magnetic layers in the quiescent state of the layer sequence are oriented essentially in parallel owing to ferromagnetic coupling, or essentially in antiparallel owing to antiferromagnetic coupling.

2. The force sensor of claim 1, wherein the thickness of the respective one separating layer is dimensioned such that the magnetic layers adjoining this separating layer are at a distance at which the magnetic coupling of the magnetic layers is at an extremum.

3. The force sensor of claim 1, wherein the magnetization directions of respectively adjacent magnetic layers in the quiescent state, are oriented essentially in antiparallel owing to antiferromagnetic coupling.

4. The force sensor of claim 1, wherein the magnetization directions of all the magnetic layers in the quiescent state, are oriented essentially in parallel owing to ferromagnetic coupling.

5. The force sensor of claim 1, wherein the angle, which is present when an external force is acting on the sequence, between the magnetization directions between two adjacent magnetic layers deviates by a maximum of 90° from the angle, which is present in the quiescent state, between the magnetization directions of these adjacent magnetic layers.

6. The force sensor of claim 1, wherein the layer sequence has a width between 0.2 μm and 200 μm.

7. The force sensor of claim 1, wherein the layer sequence has a width between 0.5 μm and 15 μm.

8. The force sensor of claim 1, wherein the layer sequence has such a length in a first lateral direction which is perpendicular to the vertical direction, and such a width in a second lateral direction which is perpendicular to the vertical direction and to the first lateral direction that the ratio between the length and the width is greater than 2:1.

9. The force sensor of claim 8, wherein the magnetization directions of the magnetic layers in the quiescent state of the layer sequence are oriented in parallel or in antiparallel to the first lateral direction.

10. The force sensor of claim 1, wherein the magnetic layers have uniaxial anisotropy in the quiescent state.

11. The force sensor of claim 1, wherein the separating layers are formed from nonmagnetic material.

12. The force sensor of claim 1, wherein at least one separating layer is made electrically conductive.

13. The force sensor of claim 12, wherein at least one electrically conductive separating layer comprises at least one of the group comprising copper (Cu) and chromium (Cr).

14. The force sensor of claim 1, wherein at least one separating layer is made electrically insulating.

15. The force sensor of claim 14, wherein at least one electrically insulating separating layer comprises at least one of the group comprising aluminum oxide (Al2O3) and magnesium oxide (MgO).

16. The force sensor of claim 1, wherein the absolute value of the magnetostriction constants of at least one magnetic layer is greater than 0.00001.

17. A method for determining a force acting on a force sensor, the method comprising:
providing a force sensor with a layer sequence with at least two electrically conductive, magnetic layers arranged in succession and spaced apart from one another in a vertical direction, one separating layer arranged between each two adjacently arranged magnetic layers, wherein the adjacently arranged magnetic layers have magnetostriction constants that are different from zero and have different signs, wherein each of the magnetic layers have one magnetization direction, wherein the magnetization directions of two adjacent magnetic layers in the quiescent state of the layer sequence are oriented essentially in parallel owing to ferromagnetic coupling, or essentially in antiparallel owing to antiferromagnetic coupling;
deforming the force sensor by means of a force acting on the layer sequence;
determining the electrical resistance of the layer sequence;
providing a characteristic curve that represents the relationship between the electrical resistance of the layer sequence and a force acting on the layer sequence;
determining the acting force using the determined resistance from the characteristic curve.

18. An array for determining the mechanical deformation in a first direction of a carrier on which four force sensors are arranged, each force sensor with a layer sequence with at least two electrically conductive, magnetic layers arranged in succession and spaced apart from one another in a vertical direction, one separating layer arranged between each two adjacently arranged magnetic layers, wherein the adjacently arranged magnetic layers have magnetostriction constants that are different from zero and have different signs, wherein each of the magnetic layers have one magnetization direction, wherein the magnetization directions of two adjacent magnetic layers in the quiescent state of the layer sequence are oriented essentially in parallel owing to ferromagnetic coupling, or essentially in antiparallel owing to antiferromagnetic coupling, the array comprising:
a first and a second of the force sensors having a longitudinal axis that is perpendicular to the first direction; and
a third and a fourth of the force sensors having a longitudinal axis which is parallel to the first direction.

19. The array of claim 18, wherein:
the first, the second, the third and the fourth force sensors are connected to form a Wheatstone bridge;
the first force sensor is connected to a first connecting point and to a second connecting point;
the third force sensor is connected to the first connecting point and to a third connecting point;
the second force sensor is connected to the third connecting point and to a fourth connecting point; and
the fourth force sensor is connected to the second connecting point and to the fourth connecting point.

20. The array of claim 18, wherein the four force sensors are in thermal contact with one another.

21. The array of claim 18 configured as a pressure sensor and wherein:
the carrier is embodied as a pressure sensor diaphragm which is attached to a diaphragm carrier and covers an opening formed therein;
the first and second force sensor are arranged in a region of the pressure sensor diaphragm in which said diaphragm is not in contact with the diaphragm carrier; and
the third and fourth force sensor are arranged in a region of the pressure sensor diaphragm in which said diaphragm is in contact with the diaphragm carrier.
